(19) United States
(12) Patent Application Publication
(10) Pub. No.: US 2024/0367416 A1
(43) Pub. Date: Nov. 7, 2024

(54) MACHINE DIRECTION ORIENTED (MDO) SEALABLE STRUCTURES

(71) Applicant: Dow Global Technologies LLC, Midland, MI (US)

(72) Inventors: Pere Puig Bosch, Tarragona (ES); Luis Gerardo Zalamea Bustillo, Horgen (CH)

(73) Assignee: Dow Global Technologies LLC, Midland, MI (US)

(21) Appl. No.: 18/681,733

(22) PCT Filed: Aug. 17, 2022
(86) PCT No.: PCT/US2022/075061

§ 371 Date: Feb. 6, 2024

Related U.S. Application Data
(60) Provisional application No. 63/235,884, filed on Aug. 23, 2021.

(51) Int. Cl. B32B 15/085; B32B 1/00; B32B 15/082; B32B 15/20; B32B 27/08; B32B 27/30; B32B 27/32; C08L 23/06; C08L 23/08; C08L 23/12; C08L 29/04; C08L 51/00

(52) U.S. Cl. CPC B32B 15/085; B32B 1/00; B32B 15/082; B32B 15/20; B32B 27/08; B32B 27/306; B32B 27/32; C08L 23/06; C08L 23/0846; C08L 23/0869; C08L 23/12; C08L 29/04; C08L 51/003; B32B 2307/72; B32B 2439/00; C08L 2205/025; C08L 2205/035; C08L 2207/066

(57) ABSTRACT

According to one embodiment of the present disclosure, a multilayer structure may comprise a machine direction oriented (MDO) multilayer film, a first layer, and a sealant layer. The a MDO multilayer film may comprise (i) a metal layer and (ii) an inner layer in adhering contact with the metal layer. The inner layer may comprise ethylene vinyl alcohol; polyvinyl alcohol; or may comprise a blend of polyethylene and an interpolymer of ethylene and methyl acrylate, ethyl acrylate, or carboxylic acid. The first layer may be extruded onto the metal layer of the machine direction oriented multilayer film. The first layer may comprise an anhydride grafted polyethylene. The sealant layer may be in adhering contact with the first layer. The sealant layer may comprise a polyethylene having a melt index (I₂) of 3 to 30 g/10 minutes and a heat seal initiation temperature of 95° C. or less.

### CROSS-REFERENCE TO RELATED APPLICATIONS

The present application claims priority to U.S. Provisional Patent Application No. 63/235,884, filed Aug. 23, 2021, and entitled “MACHINE DIRECTION ORIENTED (MDO) SEALABLE STRUCTURES,” the entirety of which is incorporated by reference herein.

### TECHNICAL FIELD

The present disclosure relates to multilayer structures and more specifically, to multilayer polymer structures comprising a machine direction oriented film.

### BACKGROUND

An inherent limitation on the use of machine direction oriented (MDO) films is the significant loss of sealing performance relative to other films. This poor sealing performance is believed to be related to the crystalline orientation, especially on the surface of the stretched films. A 20° C. to 25° C. increase in sealing temperatures is typical for MDO films, relative to other films. MDO films are also understood to have limited temperature resistance. This combination of factors results in a very narrow, or sometimes even non-existing sealing window.

Accordingly, new structures are desired which can broaden of the range between sealing and shrinkage in the composite structure, while protecting the barrier layer with coatings, in a cost effective manner.

### SUMMARY

Sealant layers should generally be capable of sealing at temperatures below the degradation temperatures of the other portions of a multilayer structure that is being sealed. Reduced sealing temperatures are desirable, since they enable reduced degradation (e.g., burning) of the other layers of the multilayer structure. Additionally, reduced sealing temperatures allow for more consistent sealing, since the sealing procedure can be run in a broader window between the degradation temperature of the film and the sealant layer's seal initiation temperature. Embodiments of the present disclosure meet this need by providing an MDO multilayer film with a metal layer, a first layer extruded onto the metal layer, and a sealant layer in adhering contact with the first layer.

According to the one embodiment of the present disclosure, a multilayer structure may comprise a machine direction oriented (MDO) multilayer film, a first layer, and a sealant layer. The MDO multilayer film may comprise (i) a metal layer and (ii) an inner layer in adhering contact with the metal layer. The inner layer may comprise ethylene vinyl alcohol; polyvinyl alcohol; or may comprise a blend of polyethylene and an interpolymer of ethylene and methyl acrylate, ethyl acrylate, or carboxylic acid. The first layer may be extruded onto the metal layer of the MDO multilayer film. The first layer may comprise an anhydride grafted polyethylene. The sealant layer may be in adhering contact with the first layer. The sealant layer may comprise a polyethylene having a melt index (I₂) of 3 to 30 g/10 minutes and a heat seal initiation temperature of 95° C. or less.

Although the concepts of the present disclosure are described herein with primary reference to metal machine direction oriented films, it is contemplated that the concepts will enjoy applicability to any multilayer films.

### DETAILED DESCRIPTION

Reference will now be made in greater detail to various embodiments, which are examples of the claimed subject matter. It should be understood that the features of the multilayered structures described in the detailed description should not be understood as limiting on the claimed embodiments unless explicitly described as such.

According to some embodiments of the present disclosure, a multilayer structure may comprise a machine direction oriented (MDO) multilayer film, a first layer, and a sealant layer. The machine direction oriented (MDO) multilayer film may comprise (i) a metal layer and (ii) an inner layer in adhering contact with the metal layer. The inner layer may comprise ethylene vinyl alcohol; polyvinyl alcohol; or may comprise a blend of polyethylene and an interpolymer of ethylene and methyl acrylate, ethyl acrylate, or carboxylic acid. The first layer may be extruded onto the metal layer of the machine direction oriented multilayer film. The first layer may comprise an anhydride grafted polyethylene (AH-g-PE). The sealant layer may be in adhering contact with the first layer. The sealant layer may comprise a polyethylene having a melt index (I2) of 3 to 30 g/10 minutes and a heat seal initiation temperature of 95° C. or less.

According to one or more embodiments, a multilayer structure may comprise a machine direction oriented film. As described herein, “machine direction oriented” films are those that are formed by uniaxially stretching of the film in the machine direction to improve physical and barrier properties. For example, the film may be heated and uniaxially stretched in the machine direction over a series of rollers. As used herein, the term “machine direction” means the length of a fabric, film, fiber, or laminate in the direction in which it is produced. Machine direction oriented films may exhibit improved tensile properties as compared with those not subjected to the machine direction orientation procedure.

A “film,” as described herein, generally includes any continuous layer of polyolefin-including material which has large length to thickness and width to thickness ratios. In one or more embodiments, a film may comprise one or more olefin-based polymers. The terms, “olefin-based polymer,” “olefinic polymer,” and “polyolefin,” as used herein, refer to a polymer that comprises, in polymerized form, a majority amount of olefin monomer, for example, ethylene or propylene (based on the weight of the polymer) and, optionally, may comprise one or more comonomers. The term “polymer” refers to a polymeric compound prepared by polymerizing monomers, whether of the same or a different type. The generic term polymer thus embraces the term “homopolymer,” usually employed to refer to polymers prepared from only one type of monomer as well as “copolymer” which refers to polymers prepared from two or more different monomers. The films described herein may be a multilayer film, which contains more than one layer.

As used herein, an “interpolymer” may refer to a polymer derived from more than one species of monomer. For example, an interpolymer may comprise 2, 3, 4, or more than 4 species of monomer. As used herein, a “terpolymer” may refer to a polymer derived from three species of monomer. The terpolymer may be characterized as a random interpolymer, a periodic interpolymer, a statistical interpolymer, or a block interpolymer. As used herein, a “random interpolymer” may refer to an interpolymer comprising multiple species of monomeric units distributed in a random sequence. As used herein, a “periodic interpolymer” may refer to an interpolymer comprising three or more species of monomeric units arranged in a repeating pattern. As used herein, a “statistical interpolymer” may refer to an interpolymer comprising two or more monomeric units with a distribution which follows a statistical rule. As used herein, a “block interpolymer” may refer to an interpolymer comprising two or more monomeric units and where the monomeric units cluster with similar monomeric units. For example, a block interpolymer may have a structure of the form AAAABBBCCC.

As described herein, “polyethylene” or an “ethylene-based polymer” shall mean polymers comprising greater than 50% by mole of units derived from ethylene monomer. This includes ethylene-based homopolymers, ethylene copolymers (meaning units derived from ethylene and an additional monomer), and ethylene interpolymer (meaning units derived from ethylene and at least one additional comonomer). These comonomers may include C₃-C₁₂ α-olefin comonomers, or may include polar comonomers. These polar comonomers may include but are not limited to those with carboxylic acid, acrylate, or acetate functionality, for example, methacrylic acid, acrylic acid, vinyl acetate, methyl acrylate, ethyl acrylate, isobutylacrylate, n-butylacrylate, glycidyl methacrylate, and monoethyl ester of maleic acid. Forms of polyethylene include, but are not limited to, Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

The term “LLDPE”, as described herein, may include resins made using Ziegler-Natta catalyst systems as well as resin made using single-site catalysts, including, but not limited to, bis-metallocene catalysts (sometimes referred to as “m-LLDPE”), phosphinimine, and constrained geometry catalysts; and resin made using post-metallocene, molecular catalysts, including, but not limited to, bis(biphenylphenoxy)catalysts (also referred to as polyvalent aryloxyether catalysts). LLDPE includes linear, substantially linear, or heterogeneous ethylene-based copolymers or homopolymers. LLDPEs contain less long chain branching than LDPEs and include the substantially linear ethylene polymers, which are further defined in U.S. Pat. Nos. 5,272,236; 5,278,272; 5,582,923; and 5,733,155; the homogeneously branched ethylene polymers such as those in U.S. Pat. No. 3,645,992; the heterogeneously branched ethylene polymers such as those prepared according to the process disclosed in U.S. Pat. No. 4,076,698; and blends thereof (such as those disclosed in U.S. Pat. No. 3,914,342 or U.S. Pat. No. 5,854,045). The LLDPE resins can be made via gas-phase, solution-phase or slurry polymerization or any combination thereof, using any type of reactor or reactor configuration known in the art. The LLDPE resins can be made via gas-phase, solution-phase, or slurry polymerization or any combination thereof, using any type of reactor or reactor configuration known in the art.

The term “ULDPE” is defined as a polyethylene-based copolymer having a density in the range of 0.895 to 0.915 g/cc.

The term “MDPE” refers to polyethylenes having densities from 0.926 to 0.935 g/cc. “MDPE” is typically made using chromium or Ziegler-Natta catalysts or using single-site catalysts including, but not limited to, bis-metallocene catalysts and constrained geometry catalysts.

Additionally, as described herein, the term “HDPE” refers to polyethylenes having densities of about 0.940 g/cm or greater, which are generally prepared with Ziegler-Natta catalysts, chrome catalysts or even metallocene catalysts.

A multilayer structure may comprise a MDO multilayer film, a first layer, and a sealant layer. As described herein, a “multilayer structure” means any structure having more than one layer. For example, the multilayer structure (for example, a film) may have two, three, four, five or more layers. A multilayer structure may be described as having the layers designated with letters. For example, a three layer structure having a core layer B, and two external layers A and C may be designated as A/B/C. Likewise, a structure having two core layers B and C and two external layers A and D would be designated A/B/C/D.

The MDO multilayer film may have a thickness of from 10 μm to 100 μm. For example, the MDO multilayer film may have a thickness of from 10 μm to 90 μm, from 10 μm to 75 μm, from 10 μm to 60 μm, from 10 μm to 45 μm, from 10 μm to 30 μm, from 20 μm to 100 μm, from 20 μm to 90 μm, from 20 μm to 75 μm, from 20 μm to 60 μm, from 20 μm to 45 μm, from 20 μm to 30 μm, or any subset thereof.

According to one or more embodiments, the machine direction oriented film may have a melting point of less than or equal to 150° C., such as less than or equal to 145° C., or even less than or equal to 140° C. This is in contrast to other films, which may have greater melting points. For example, polypropylene films may have melting points of greater than 150° C., and polyethylene terephthalate films may have melting points of greater than 250° C.

The MDO multilayer film may comprise (i) a metal layer and (ii) an inner layer in adhering contact with the metal layer. The term “in adhering contact” and like terms mean that one facial surface of one layer and one facial surface of another layer are in touching and binding contact to one another such that one layer cannot be removed from the other layer without damage to the interlayer surfaces (i.e., the in-contact facial surfaces) of both layers.

The metal layer may comprise oxides of aluminum or silicon. For example, the oxides of aluminum may be Al₂O₃ and the oxides of silicon may be SiO₂. According to some embodiments, the metal layer may comprise oxides of aluminum and oxides of silicon. In some embodiments, the metal layer may be a decorative layer included to add gloss to a flexible package. The skilled person would be familiar with these metal layers, which are typically foil layers.

In some embodiments, the metal layer may be a metallized layer applied to the outer layer of the MDO multilayer film using vacuum metallization. While various thicknesses are contemplated, when the metal layer is a metallized layer, the metallized layer may in one or more embodiments have a thickness of less than 100 nanometers, or from 10 to 80 nanometers, or from 20 to 60 nanometers.

The metal layer may be a foil layer. When the metal layer is a foil layer, the foil layer may have a thickness of from 6 to 15 μm, from 6 to 12 μm, from 10 to 15 μm, from 8 to 12 μm, or any subset thereof.

The metal layer may be a foil layer adhered to the rest of the MDO multilayer film with a tie layer. The tie layer may comprise a maleated polyethylene, a copolymer of ethylene and carboxylic acid, or both. As used herein, a “maleated” substance is one which comprises a salt or ester of maleic acid.

Referring again to the MDO multilayer film, the MDO multilayer film may have five layers and the structure A/B/C/D/E where layer A is the inner layer and the metal layer is on the surface of layer A. Layer A may have a thickness of from 10% to 20% of the total thickness of the MDO multilayer film. Layer B may have a thickness of from 10% to 20% of the total thickness of the MDO multilayer film. Layer C may have a thickness of from 20% to 40% of the total thickness of the MDO multilayer film. Layer D may have a thickness of from 10% to 30% of the total thickness of the MDO multilayer film. Layer E may have a thickness of from 10% to 30% of the total thickness of the MDO multilayer film. The layers may be extruded one atop the other. The MDO multilayer film may have one or more polyethylene layers. For example, the MDO multilayer film may have 2, 3, 4, or 5 polyethylene layers.

As stated previously, Layer A, which is the inner layer, comprises at least one polymer having at least one polar monomer. For example, the inner layer (Layer A) may comprise one or more of an ethylene vinyl-alcohol interpolymer (EVOH), a polyvinyl-alcohol interpolymer (PVOH), polyethylene resin, a mixture of a polyethylene resin and an interpolymer of ethylene and acrylate, or a mixture of polyethylene resin and an interpolymer of ethylene and a carboxylic acid.

For inner layer embodiments including EVOH, the EVOH may have a density from 0.90 g/cm³ to 1.40 g/cm³, or from 0.95 g/cm³ to 1.20 g/cm³, or any subset thereof. Layer A may have a melt index of from 0.70 g/10 min to 1.9 g/10 min. The EVOH may have a melt index of from 1.00 g/10 min to 3.00 g/10 min, or from 1.00 g/10 min to 2.50 g/10 min, or from 1.50 g/10 min to 2.00 g/10 min, or any subset thereof. The EVOH may have a melting temperature of from 120° C. to 250° C., or 150° C. to 200, or any subset thereof. Suitable commercial examples of the EVOH may include the EVAL E171B, F171B, and J171B commercial grades available from EVAL Europe NV.

For inner layer embodiments including polyethylene resin, the polyethylene may be an ethylene-α-olefin copolymer having a density from 0.940 g/cm³ to 0.975 g/cm³, or from 0.945 g/cm³ to 0.970 g/cm³, or from 0.950 g/cm³ to 0.965 g/cm³, or any subset thereof. The ethylene-α-olefin copolymer may have a melt index of from 0.5 g/10 min to 3.00 g/10 min, or from 0.75 g/10 min to 2.00 g/10 min, or any subset thereof. The ethylene-α-olefin copolymer may be an LLDPE. Suitable commercial LLDPE resins may include DOWLEX™ 2750ST from Dow Inc., Midland, MI. Additionally, suitable commercial examples may include the ELITE™ 5960G1 enhanced polyethylene from Dow Inc., Midland, MI.

For inner layer embodiments including the interpolymer of ethylene and acrylate, the acrylate may comprise any suitable C2-C12 acrylate, for example, methyl acrylate, ethyl acrylate, isobutylacrylate, n-butyl acrylate, and glycidyl methacrylate. In one embodiment, the acrylate comprises n-butyl acrylate. In terms of monomer amount, the ethylene-acrylate comonomer may comprise 10 to 40% by wt. of acrylate, or from 15 to 35 wt. % of acrylate, or from 20 to 30 wt. % acrylate with the balance comprising ethylene monomer. The interpolymer of ethylene and acrylate may have a density from 0.910 g/cm³ to 0.955 g/cm³, or from 0.920 g/cm³ to 0.950 g/cm³, or from 0.925 g/cm³ to 0.945 g/cm³, or any subset thereof. The interpolymer of ethylene and acrylate may have a melt index of from 0.5 g/10 min to 5.00 g/10 min, or from 1.00 g/10 min to 4.50 g/10 min, or from 1.50 g/10 min to 4.00 g/10 min, or any subset thereof. Suitable commercial examples may include ELVALOY™ AC grades 1224, 3117, and 3427 from Dow Inc., Midland, MI.

Layer B may also comprise one or more polyethylenes. The polyethylene(s) may have a density of from 0.910 g/cm³ to 0.950 g/cm³, or from 0.915 to 0.945 g/cm³. In some embodiments, there may be a mixture of lesser density polyethylene (from 0.910 g/cm³ to 0.920 g/cm³) and greater density polyethylene (from 0.930 g/cm³ to 0.945 g/cm³). The polyethylene(s) may have a melt index of from 0.25 g/10 min to 2.0 g/10 min, or from 0.50 g/10 min to 1.5 g/10 min, or from 0.75 g/10 min to 1.25 g/10 min, or any subset thereof. The polyethylene(s) in Layer B may have a melting temperature of from 100° C. to 140° C., or from 110° C. to 130° C., or from 115° C. to 130° C., or any subset thereof. Suitable commercial examples may include the ELITE™ 5400GS and 5940ST enhanced polyethylenes from Dow Inc., Midland, MI, which may be used individually or in a blend.

In other embodiments, layer B may include a tie layer comprising ethylene and acid copolymers. In one or more embodiments, the tie layers may include an anhydride-grafted ethylene/alpha-olefin interpolymer. The term, “anhydride-grafted ethylene/alpha-olefin interpolymer,” as used herein, refers to an ethylene/alpha-olefin interpolymer that comprises at least one anhydride group linked by a covalent bond. The anhydride-grafted ethylene/alpha-olefin interpolymer may be an ethylene-based polymer with an anhydride grafting monomer grafted thereto. Suitable ethylene-based polymers for the low-melt viscosity anhydride-grafted polyolefin include, without limitation, polyethylene homopolymers and copolymers with α-olefins, copolymers of ethylene and vinyl acetate, and copolymers of ethylene and one or more alkyl (meth)acrylates. In specific embodiments, the anhydride-grafted ethylene/alpha-olefin interpolymer may comprise a maleic anhydride-grafted linear low density polyethylene (LLDPE).

In one or more embodiments, the anhydride-grafted ethylene/alpha-olefin interpolymer comprises up to 10 wt. %, up to 5 wt. %, or from 0.1 to 4 wt. % of the anhydride grafting monomer, based on the total weight of the anhydride-grafted ethylene/alpha-olefin interpolymer. In one or more embodiments, the anhydride-grafted ethylene/alpha-olefin interpolymer comprises up to 10 wt. %, up to 5 wt. %, or from 0.1 to 4 wt. % of a maleic anhydride grafting monomer, based on the total weight of the anhydride-grafted ethylene/alpha-olefin interpolymer.

Examples of anhydride grafting moieties may include but are not limited to, maleic anhydride, citraconic anhydride, 2-methyl maleic anhydride, 2-chloromaleic anhydride, 2,3-dimethylmaleic anhydride, bicyclo[2,2,1]-5-heptene-2,3-dicarboxylic anhydride and 4-methyl-4-cyclohexene-1,2-dicarboxylic anhydride, bicyclo(2.2.2)oct-5-ene-2,3-dicarboxylic acid anhydride, lo-octahydronaphthalene-2,3-dicarboxylic acid anhydride, 2-oxa-1,3-diketospiro(4.4)non-7-ene, bicyclo(2.2.1)hept-5-ene-2,3-dicarboxylic acid anhydride, tetrahydrophtalic anhydride, norbom-5-ene-2,3-dicarboxylic acid anhydride, nadic anhydride, methyl nadic anhydride, himic anhydride, methyl himic anhydride, and x-methyl-bi-cyclo(2.2.1)hept-5-ene-2,3-dicarboxylic acid anhydride. In one embodiment, the anhydride grafting moiety comprises maleic anhydride.

In further embodiments, the anhydride-grafted ethylene/alpha-olefin interpolymer has a density from 0.890 g/cm³ to 0.940 g/cm³, as measured according to ASTM Method No. D792-91. Other density ranges may be from 0.900 g/cm³ to 0.930 g/cm³, or from 0.905 g/cm³ to 0.915 g/cm³. In one or more embodiments, the anhydride-grafted ethylene/alpha-olefin interpolymer may have a melt index (12) of 0.5 g/10 min to 3 g/10 min, or from 1 g/10 min to 2 g/10 min, or from 1.5 g/10 min to 2.0 g/10 min as determined in accordance with ASTM method D1238 at 190° C. and 2.16 kg. Suitable commercial examples of the anhydride-grafted ethylene/alpha-olefin interpolymer may include BYNEL™ 41E687B from Dow Inc., Midland, MI.

Layers C and D may also comprise one or more polyethylenes. Like layer B, the polyethylene(s) may have a density of from 0.910 g/cm³ to 0.950 g/cm³, or from 0.915 to 0.945 g/cm³. In some embodiments, there may be a mixture of lesser density polyethylene (from 0.910 g/cm³ to 0.920 g/cm³) and greater density polyethylene (from 0.930 g/cm³ to 0.945 g/cm³). The polyethylene(s) may have a melt index of from 0.25 g/10 min to 2.0 g/10 min, or from 0.50 g/10 min to 1.5 g/10 min, or from 0.75 g/10 min to 1.25 g/10 min, or any subset thereof. The polyethylene(s) in Layer B may have a melting temperature of from 100° C. to 140° C., or from 110° C. to 130° C., or from 115° C. to 130° C., or any subset thereof. Suitable commercial examples may include the ELITE™ 5400GS and 5940ST enhanced polyethylenes from Dow Inc., Midland, MI, which may be used individually or in a blend.

Layer E may also comprise one or more polyethyelene resins. The polyethylene(s) may be an ethylene-α-olefin copolymer having a density from 0.940 g/cm³ to 0.975 g/cm³, or from 0.945 g/cm³ to 0.970 g/cm³, or from 0.950 g/cm³ to 0.965 g/cm³, or any subset thereof. The ethylene-α-olefin copolymer may have a melt index of from 0.5 g/10 min to 3.00 g/10 min, or from 0.75 g/10 min to 2.00 g/10 min, or any subset thereof. The ethylene-α-olefin copolymer may be an LLDPE. Suitable commercial LLDPE resins may include DOWLEX™ 2750ST from Dow Inc., Midland, MI. Additionally, suitable commercial examples may include the ELITE™ 5960G1 enhanced polyethylene from Dow Inc., Midland, MI.

Referring again to the first layer as described above, the first layer may be extruded onto the metal layer of the machine direction oriented multilayer film. As described herein, extruding a first layer may include forming the first layer through a die to form the desired layer thickness and other physical characteristics.

The first layer may have been extruded onto the MDO multilayer film at a loading of from 2 grams per square meter (gsm) to 16 gsm. For example, the first layer may have a loading of from 2 gsm to 12 gsm, 2 gsm to 8 gsm, 2 gsm to 6 gsm, 4 gsm to 16 gsm, 4 gsm to 12 gsm, 4 gsm to 8 gsm, or any subset thereof.

The first layer may comprise an anhydride grafted polyethylene (AH-g-PE). For example, the anhydride-grafted polyethylene may comprise maleic anhydride grafted polyethylene (MAH-g-PE). The first layer may comprise from 50 wt. % to 98 wt. % of the AH-g-PE. For example, the first layer may comprise from 60 wt. % to 98 wt. %, from 70 wt. % to 98 wt. %, from 80 wt. % to 98 wt. %, from 90 wt. % to 98 wt. %, from 50 wt. % to 90 wt. %, from 50 wt. % to 80 wt. %, 50 wt. % to 70 wt. %, from 50 wt. % to 60 wt. %, from 60 wt. % to 90 wt. %, from 70 wt. % to 80 wt. %, or any subset thereof, of the AH-g-PE.

The term “anhydride-grafted polyethylene,” as used herein, refers to an ethylene based interpolymer that comprises at least one anhydride group linked by a covalent bond. The anhydride-grafted polyethylene interpolymer may be an ethylene-based polymer with an anhydride grafting monomer grafted thereto. Suitable ethylene-based polymers for the low-melt viscosity maleic anhydride-grafted polyolefin include, without limitation, polyethylene homopolymers and copolymers with α-olefins, copolymers of ethylene and vinyl acetate, and copolymers of ethylene and one or more alkyl (meth)acrylates. In specific embodiments, the anhydride-grafted ethylene/alpha-olefin interpolymer may comprise a maleic anhydride-grafted linear low density polyethylene (LLDPE).

In one or more embodiments, the anhydride-grafted polyethylene comprises up to 10 wt. %, up to 5 wt. %, or from 0.1 to 4 wt. % of the anhydride grafting monomer, based on the total weight of the anhydride-grafted polyethylene.

Examples of anhydride grafting moieties may include but are not limited to, maleic anhydride, citraconic anhydride, 2-methyl maleic anhydride, 2-chloromaleic anhydride, 2,3-dimethylmaleic anhydride, bicyclo[2,2,1]-5-heptene-2,3-dicarboxylic anhydride and 4-methyl-4-cyclohexene-1,2-dicarboxylic anhydride, bicyclo(2.2.2)oct-5-ene-2,3-dicarboxylic acid anhydride, lo-octahydronaphthalene-2,3-dicarboxylic acid anhydride, 2-oxa-1,3-diketospiro(4.4)non-7-ene, bicyclo(2.2.1)hept-5-ene-2,3-dicarboxylic acid anhydride, tetrahydrophtalic anhydride, norbom-5-ene-2,3-dicarboxylic acid anhydride, nadic anhydride, methyl nadic anhydride, himic anhydride, methyl himic anhydride, and x-methyl-bi-cyclo(2.2.1)hept-5-ene-2,3-dicarboxylic acid anhydride. In one embodiment, the anhydride grafting moiety comprises maleic anhydride.

In further embodiments, the anhydride-grafted polyethylene (AH-g-PE) f has a density from 0.890 g/cm³ to 0.940 g/cm³, as measured according to ASTM Method No. D792-91. Other density ranges may be from 0.900 g/cm³ to 0.930 g/cm³, or from 0.905 g/cm³ to 0.915 g/cm³. In one or more embodiments, the anhydride-grafted polyethylene may have a melt index (12) of 0.5 g/10 min to 3 g/10 min, or from 1 g/10 min to 2 g/10 min, or from 1.5 g/10 min to 2.0 g/10 min as determined in accordance with ASTM method D1238 at 190° C. and 2.16 kg. Suitable commercial examples of the anhydride-grafted polyethylene may include BYNEL™ 41E687B from Dow Inc., Midland, MI.

The first layer may comprise an interpolymer of ethylene and acrylic acid or methacrylic acid. According to some embodiments, the AH-g-PE may comprise an interpolymer of ethylene and acrylic acid or methacrylic acid.

The interpolymer of the first layer may comprise from 50 wt. % to 98 wt. % ethylene monomer. For example, the interpolymer of the first layer may comprise from 60 wt. % to 98 wt. %, from 70 wt. % to 98 wt. %, from 80 wt. % to 98 wt. %, from 90 wt. % to 98 wt. %, from 50 wt. % to 90 wt. %, from 50 wt. % to 80 wt. %, 50 wt. % to 70 wt. %, from 50 wt. % to 60 wt. %, from 60 wt. % to 90 wt. %, from 70 wt. % to 80 wt. %, or any subset thereof, of ethylene.

The interpolymer of the first layer may have a melt index (I₂) of 5 to 20 g/10 minutes. For example, the interpolymer of the first layer may have an I₂ of 5 to 18 g/10 minutes, 8 to 20 g/10 minutes, 8 to 18 g/10 minutes, 5 to 15 g/10 minutes, 12 to 20 g/10 minutes, 12 to 15 g/10 minutes, or any subset thereof. As used herein, “melt index” (I₂) is a measure of melt flow rate of a polymer as measured by ASTM D1238 at a temperature of 190° C. and a 2.16 kg load. “Melt index” may also be referred to herein as “I₂” and “melt flow rate.”

The interpolymer of the first layer may have an acid content of from 1 to 10 weight percent (wt. %). As used herein, the “acid content” refers to the quantity of acrylic acid relative to the total weight of the interpolymer. For example, the interpolymer of the first layer may have an acid content of from 1 wt. % to 9 wt. %, from 1 wt. % to 8 wt. %, from 1 wt. % to 6 wt. %, from 2 wt. % to 10 wt. %, from 3 wt. % to 10 wt. %, from 4 wt. % to 10 wt. %, from 2 wt. % to 8 wt. %, from 3 wt. % to 7 wt. %, from 4 wt. % to 6 wt. %, or any subset thereof.

The interpolymer of the first layer may have a melting temperature of from 90° C. to 100° C. For example, the interpolymer of the first layer may have a melting temperature of from 90° C. to 98° C., from 90° C. to 96° C., from 90° C. to 94° C., from 90° C. to 92° C., from 92° C. to 98° C., from 92° C. to 96° C., from 92° C. to 94° C., from 94° C. to 98° C., from 94° C. to 96° C., from 96° C. to 98° C., or any subset thereof.

The interpolymer of the first layer may be a terpolymer of ethylene; acrylic acid or methacrylic acid; and alkyl acrylate. For example, the interpolymer of the first layer may be a terpolymer of ethylene, acryclic acid, and alkyl acrylate or the interpolymer of the first layer may be a terpolymer of ethylene, methacrylic acid, and alkyl acrylate. In one or more embodiments of the present disclosure, the interpolymer may be a member of the NUCREL™ line available from Dow Inc, Midland, MI.

The multilayer structure may comprise a sealant layer. The sealant layer may generally be heated and pressed to seal two multilayer structures to one another by their sealant layers. The sealant layer may be in adhering contact with the first layer.

In one or more embodiments, the sealant layer may be in adhering contact with the first layer. In one or more embodiments, the sealant layer may be extruded onto the first layer. As described herein, extruding a sealant layer may include forming the sealant layer through a die to form the desired layer thickness and other physical characteristics.

The sealant layer may have been extruded onto the first layer at a loading of from 10 grams gsm to 30 gsm. For example, the sealant layer may have a loading of from 10 gsm to 26 gsm, 10 gsm to 24 gsm, 10 gsm to 21 gsm, 14 gsm to 30 gsm, 14 gsm to 26 gsm, 14 gsm to 24 gsm, 14 gsm to 21 gsm, 18 gsm to 30 gsm, 18 gsm to 24 gsm, 18 gsm to 21 gsm, 18 gsm to 20 gsm, or any subset thereof.

The sealant layer may comprise 60 wt. % to 85 wt. % of at least one polyethylene. For example, the sealant layer may comprise from 60 wt. % to 80 wt. %, from 60 wt. % to 75 wt. %, from 60 wt. % to 70 wt. %, from 65 wt. % to 85 wt. %, from 70 wt. %, to 85 wt. %, from 75 wt. % to 85 wt. %, from 65 wt. % to 80 wt. %, from 70 wt. % to 75 wt. %, or any subset thereof, of at least one polyethylene.

The sealant layer may comprise a polyethylene having a density of from 0.870 grams per cubic centimeter (g/cc) to 0.911 g/cc. For example, the sealant layer may comprise a polyethylene having a density of from 0.870 g/cc to 0.901 g/cc, from 0.870 g/cc to 0.891 g/cc, from 0.870 g/cc to 0.881 g/cc, from 0.880 g/cc to 0.911 g/cc, from 0.890 g/cc to 0.911 g/cc, from 0.901 g/cc to 0.911 g/cc, from 0.880 g/cc to 0.901 g/cc, or any subset thereof.

The sealant layer may comprise a polyethylene having a melt index (12) of at least 3 g/10 minutes. For example, the sealant layer may comprise a polyethylene having an I2 of at least 4 g/10 minutes, at least 5 g/10 minutes, at least 7.5 g/10 minutes, at least 10 g/10 minutes, at least 15 g/10 minutes, at least 20 g/10 minutes, at least 25 g/10 minutes, or even at least 30 g/10 minutes.

The sealant layer may comprise a polyethylene having a melt index (12) of 3 to 30 g/10 minutes. For example, the sealant layer may comprise a polyethylene having a melt index (12) of 3 to 25 g/10 minutes, 3 to 15 g/10 minutes, 3 to 10 g/10 minutes, 5 to 30 g/10 minutes, 5 to 25 g/10 minutes, 10 to 30 g/10 minutes, 10 to 20 g/10 minutes, 15 to 30 g/10 minutes, 15 to 25 g/10 minutes, or any subset thereof. As used herein, melt index (12) is a measure of melt flow rate of a polymer as measured by ASTM D1238 at a temperature of 190° C. and a 2.16 kg load.

The sealant layer may comprise a polyethylene having a heat seal initiation temperature of 95° C. or less. For example, the sealant layer may comprise a polyethylene having a heat seal initiation temperature of 92.5° C. or less, 90° C. or less, 87.5° C. or less, 85° C. or less, 82.5° C. or less, 80° C. or less, 75° C. or less, or even 70° C. or less. The heat seal initiation temperature is the temperature at which a seal strength of 1 newtons/15 mm of seal width may be formed. The seal strength should be measured according to ASTM F1921.

In one or more embodiments, the sealant layer may comprise a low density polyethylene. As described herein, the term “LDPE” may also be referred to as “high pressure ethylene polymer” or “highly branched polyethylene” and is defined to mean that the polymer may be partly or entirely homopolymerized or copolymerized in autoclave or tubular reactors at pressures above 14,500 psi (100 MPa) with the use of free-radical initiators, such as peroxides (see, for example, U.S. Pat. No. 4,599,392, which is hereby incorporated by reference). LDPE resins typically have a density in the range of 0.916 to 0.940 g/cm.

According to one or more embodiments, the sealant layer may comprise from 15 to 40 percent by weight (wt. %) of a low density polyethylene based on the total weight of the sealant layer. For example, the sealant layer may comprise from 15 wt. % to 20 wt. %, from 20 wt. % to 25 wt. %, from 25 wt. % to 30 wt. %, from 30 wt. % to 35 wt. %, from 35 wt. % to 40 wt. %, or combinations of any of these ranges, of a low density polyethylene based on the total weight of the sealant layer. In additional embodiments, the sealant layer may comprise from 15 wt. % to 30 wt. % of a low density polyethylene based on the total weight of the sealant layer.

In one or more embodiments, the low density polyethylene of the sealant layer may have a melt index (12) of from 0.5 g/10 minutes to 3.5 g/10 minutes. For example, the low density polyethylene of the sealant layer may have a melt index of from 0.9 g/10 minutes to 3.0 g/10 minutes, from 0.9 g/10 minutes to 2.8 g/10 minutes, from 0.9 g/10 minutes to 2.5 g/10 minutes, from 1.1 g/10 minutes to 3.5 g/10 minutes, from 1.4 g/10 minutes to 3.5 g/10 minutes, from 1.1 g/10 minutes to 3.0 g/10 minutes, from 1.3 g/10 minutes to 2.5 g/10 minutes, or any subset thereof.

In one or more embodiments, the low density polyethylene of the sealant layer may be chosen from DOW™ LDPE 770G (commercially available from Dow Inc, Midland, MI), which has a density of 0.913 g/cm³, a melt index of 2.3 g/10 minutes, and a melting point of 110° C., or AGILITY™ EC 7220 Performance LDPE (commercially available from Dow Inc, Midland, MI), which has a density of 0.918 g/cm³ and a melt index of 1.5 g/10 minutes. However, other LDPE's are contemplated for use in the sealant layer, and embodiments described herein are not limited to those including these polymers.

The sealant layer may also comprise a propylene-based plastomer. As described herein, a “propylene-based plastomer” refers to a plastomer that includes greater than 50% by mole of units derived from propylene monomer. This includes propylene-based homopolymers or interpolymers (meaning units derived from two or more monomers). Plastomers may generally be understood as polymeric materials which combine qualities of elastomers and thermoplastics.

According to one or more embodiments, the sealant layer may comprise from 60 wt. % to 85 wt. % of a propylene-based plastomer based on the total weight of the sealant layer. For example, the sealant layer may comprise from 60 wt. % to 65 wt. %, from 65 wt. % to 70 wt. %, from 70 wt. % to 75 wt. %, from 75 wt. % to 80 wt. %, from 80 wt. % to 85 wt. %, or any combination of these ranges, of a propylene-based plastomer based on the total weight of the sealant layer.

According to one or more embodiments, the propylene-based plastomer may have a density of 0.890 g/cm³ or less. For example, the propylene-based plastomer may have a density of from 0.860 g/cm³ to 0.890 g/cm³, such as from 0.860 g/cm³ to 0.865 g/cm³, from 0.865 g/cm³ to 0.870 g/cm³, from 0.870 g/cm³ to 0.875 g/cm³, from 0.875 g/cm³ to 0.880 g/cm³, from 0.880 g/cm³ to 0.885 g/cm³, from 0.885 g/cm³ to 0.890 g/cm³, or any combination of these ranges.

In one or more embodiments, the propylene-based plastomer may have a melt index (12) (at 230° C. and 2.16 kg) of at least 8 g/10 minutes. For example, the propylene-based plastomer may have a melt flow rate (at 230° C. and 2.16 kg) of from 8 g/10 minutes to 35 g/10 minutes, such as from 8 g/10 minutes to 15 g/10 minutes, from 15 g/10 minutes to 20 g/10 minutes, from 20 g/10 minutes to 25 g/10 minutes, from 25 g/10 minutes to 30 g/10 minutes, from 30 g/10 minutes to 35 g/10 minutes, or any combination of these ranges. Unless otherwise specified, as described herein, the melt index (12) is measured in accordance with ASTM D 1238-10, Condition 230° C./2.16 kg, and is reported in grams eluted per 10 minutes.

In one or more embodiments, the propylene-based plastomer may have a melting point of from 70° C. to 100° C. For example, the propylene-based plastomer may have a melting point of from 70° C. to 80° C., from 80° C. to 90° C., from 90° C. to 100° C., or any combination of these ranges.

In one or more embodiments, the propylene-based plastomer may be an interpolymer comprising units of propylene and ethylene. According to one or more embodiments, the propylene-based plastomer may have an ethylene content of from 2 mol. % to 12 mol. %. For example, the propylene-based plastomer may have an ethylene content of from 2 mol. % to 4 mol. %, from 4 mol. % to 6 mol. %, from 6 mol. % to 8 mol. %, from 8 mol. % to 10 mol. %, from 10 mol. % to 12 mol. %, or any combination of these ranges.

In one or more embodiments, the propylene-based plastomer may be VERSIFY™ 4200 Plastomer (commercially available from Dow Inc, Midland, MI), which has a density of 0.876 g/cm³, melt index of 25 g/10 minutes, and melting point of 84° C. However, other propylene-based plastomers are contemplated for use in the sealant layer, and embodiments described herein are not limited to those including these polymers.

According to one or more embodiments, the sealant layer may comprise a combination of a low density polyethylene and a propylene-based plastomer. For example, the sealant layer may comprise from 15 wt. % to 40 wt. % of a low density polyethylene and from 60 wt. % to 85 wt. % of a propylene-based plastomer based on the total weight of the sealant layer.

Embodiments of the present disclosure also relate to articles, such as packages, formed from the multilayer structures of the present disclosure. Such packages can be formed from any of the multilayer structures of the present disclosure described herein. Examples of such articles can include flexible packages, pouches, stand-up pouches, and pre-made packages or pouches. According to specific embodiments of the present disclosure, the article may be a pouch.

The pouch may have a length of at least 25 mm. For example, the pouch may have a length of at least 50 mm, at least 75 mm, at least 100 mm, at least 150 mm, or at least 200 mm. The pouch may have a width of at least 25 mm. For example, the pouch may have a width of at least 50 mm, at least 75 mm, at least 100 mm, at least 150 mm, or at least 200 mm.

The pouch may have a volume of at least 25 milliliters (ml). For example, the pouch may have a volume of at least 50 ml, at least 75 ml, at least 100 ml, at least 150 ml, at least 200 ml, at least 250 ml, at least 300 ml, at least 400 ml, at least 500 ml, at least 750 ml, at least 1000 ml, at least 1500 ml, at least 2000 ml, or at least 2500 ml.

The pouch may have a sealed layer. The sealed layer may be the spot where two layers of pouch were fused together under heat and pressure. The sealed layer may have a peel strength of at least 3 newtons per 15 mm width of seal (N/15 mm). For example, the sealed layer may have a peel strength of at least 4 N/15 mm, at least 5 N/15 mm, or at least 6 N/15 mm. The seal strength may be measured according to ASTM D903.

Numerous aspects are disclosed herein. A first aspect may include a multilayer structure comprising: (a) a machine direction oriented (MDO) multilayer film comprising (i) a metal layer and (ii) an inner layer in adhering contact with the metal layer, wherein the inner layer comprises: ethylene vinyl alcohol; polyvinyl alcohol; or a blend of polyethylene and an interpolymer of ethylene and methyl acrylate, ethyl acrylate, or carboxylic acid; (b) a first layer extruded onto the metal layer of the machine direction oriented multilayer film wherein the first layer comprises an anhydride grafted polyethylene (AH-g-PE); and (c) a sealant layer in adhering contact with the first layer, wherein the sealant layer comprises a polyethylene having a melt index (I2) of 3 to 30 g/10 minutes and a heat seal initiation temperature of 95° C. or less.

Another aspect may include any previous aspect, wherein the metal layer comprises oxides of aluminum or silicon.

Another aspect may include any previous aspect, wherein the AH-g-PE of the first layer is a terpolymer of ethylene; acrylic acid or methacrylic acid; and alkyl acrylate.

Another aspect may include any previous aspect, wherein the AH-g-PE of the first layer comprises 50 to 98 wt. % ethylene.

Another aspect may include any previous aspect, wherein the sealant layer comprises 15 to 40 percent by weight of a low density polyethylene based on the total weight of the sealant layer.

Another aspect may include any previous aspect, wherein the sealant layer further comprises 60 to 85 percent by weight of a propylene-based plastomer having a density of 0.890 g/cc or less and a melt flow rate (at 230° C. and 2.16 kg) of at least 8 g/10 minutes.

Another aspect may include any previous aspect, wherein n the sealant layer further comprises 60 to 85 percent by weight of at least one polyethylene having a density of 0.870 g/cc to 0.911 g/cc and a melt index (12) of at least 3 g/10 minutes.

Another aspect may include any previous aspect, wherein the MDO multilayer film has one or more polyethylene layers.

Another aspect is an article comprising the multilayer structure of any preceding aspect.

Another aspect may include any previous aspect, wherein the article is a pouch.

It is also noted that recitations herein of “at least one” component, element, etc., should not be used to create an inference that the alternative use of the articles “a” or “an” should be limited to a single component, element, etc.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. A multilayer structure comprising:
(a) a machine direction oriented (MDO) multilayer film comprising (i) a metal layer and (ii) an inner layer in adhering contact with the metal layer, wherein the inner layer comprises:
ethylene vinyl alcohol;
polyvinyl alcohol; or
a blend of polyethylene and an interpolymer of ethylene and
methyl acrylate,
ethyl acrylate,
or carboxylic acid;
(b) a first layer extruded onto the metal layer of the machine direction oriented multilayer film wherein the first layer comprises an anhydride grafted polyethylene (AH-g-PE); and
(c) a sealant layer in adhering contact with the first layer, wherein the sealant layer comprises a polyethylene having a melt index (I₂) of 3 to 30 g/10 minutes and a heat seal initiation temperature of 95° C. or less.

2. The multilayer structure of claim 1, wherein the metal layer comprises oxides of aluminum or silicon.

3. The multilayer structure of claim 1, wherein the AH-g-PE of the first layer is a terpolymer of ethylene; acrylic acid or methacrylic acid; and alkyl acrylate.

4. The multilayer structure of claim 1, wherein the AH-g-PE of the first layer comprises 50 to 98 wt. % ethylene.

5. The multilayer structure of claim 1, wherein the sealant layer comprises 15 to 40 percent by weight of a low density polyethylene based on the total weight of the sealant layer.

6. The multilayer structure of claim 1, wherein the sealant layer further comprises 60 to 85 percent by weight of a propylene-based plastomer having a density of 0.890 g/cc or less and a melt flow rate (at 230° C. and 2.16 kg) of at least 8 g/10 minutes.

7. The multilayer structure of claim 1, wherein the sealant layer further comprises 60 to 85 percent by weight of at least one polyethylene having a density of 0.870 g/cc to 0.911 g/cc and a melt index (I2) of at least 3 g/10 minutes.

8. The multilayer structure of claim 1, wherein the MDO multilayer film has one or more polyethylene layers.

9. An article comprising the multilayer structure of claim 1.

10. The article of claim 9, wherein the article is a pouch.
